(19) United States
(12) Patent Application Publication
(10) Pub. No.: US 2026/0178661 A1
(43) Pub. Date: Jun. 25, 2026

(54) SYSTEMS AND METHODS FOR PROVIDING ENHANCEMENTS FOR DEEMPHASIZED CONTENT

(71) Applicant: Adeia Guides Inc., San Jose, CA (US)

(72) Inventors: Zhiyun Li, Kenmore, WA (US); Toshiro Ozawa, Irvine, CA (US); Ning Xu, Irvine, CA (US)

(21) Appl. No.: 18/990,935

(22) Filed: Dec. 20, 2024

(51) Int. Cl. G06F 16/783; G06F 3/01; G06F 16/735; G06F 40/109; G10L 25/51

(52) U.S. Cl. CPC G06F 16/7844; G06F 3/013; G06F 16/735; G06F 16/7834; G06F 40/109; G10L 25/51

(57) ABSTRACT

Systems and methods are disclosed for enhancing output of deemphasized content. A content item may be provided for output on a device. One or more attributes associated with text and/or audio in at least one segment of a content item may be identified. The attributes of the text and/or audio may not be present in other segments of the content item. Based on determining that the attributes of the text and/or audio indicate an intent to deemphasize the text and/or audio, the output of the text and/or audio on the device is enhanced.

### BACKGROUND

This disclosure relates to enhancing output of deemphasized content in media.

### SUMMARY

When presenting media that involves user actions or decisions, it is important to include disclosure content to help the users make informed choices. For example, disclosure content may include fine print, disclaimers, terms and conditions, warnings, legal information, representations and warranties, expiration dates, information required for compliance with regulations, fees, information verification, or other suitable information. However, many times, content providers deemphasize the output of such disclosure content, which can result in users being misinformed or overlooking important information. Additionally, or alternatively, the output may be presented in such a way that fails to effectively capture the user's attention and is easily overlooked by the user.

For example, the disclosure content may be formatted in ways that are likely to reduce a user's attention to it, such as by reducing font size of disclosure text, placing disclosure text at a position in the media item where the user is less likely to read (e.g., bottom of screen), or playing disclosure audio at a high speed, low tone, or low volume. In other examples, content providers may distract the user from digesting the disclosure content, by presenting the disclosure content and the rest of the content in unrelated manners. For instance, audio may be played with a serious tone describing serious side effects of a medication, while also presenting a scene with upbeat music and characters expressing positive emotions. Such dissonance may distract a user from paying attention to, or may lead to the user miscomprehending, medically relevant information disclosed in the audio. In other examples, limited screen space, screen time, or air time may affect how disclosure content is presented, such as whether it is presented to the user in an effective way. For instance, a statewide public service announcement for evacuation may include different evacuation instructions for different zip codes. To present the various instructions at the same time, such instructions may need to be provided in a small font, or the separate instructions for each zip code may be cycled through quickly, such that users may miss important information pertinent to their area.

In one approach, user interface (UI) elements for playback control may be provided that allow a user to pause, slow down, or increase the volume of the media item and consume the disclosure content more carefully. However, pausing or slowing the media item can disrupt the viewing of the media item, and may not be possible or effective when a user does not have convenient access to control a display or media device. Moreover, providing user controls is not always possible, due to various factors such as the medium for providing the media item. For instance, a user cannot pause or slow down a live radio broadcast or display that is provided in a public space.

In another approach, closed captioning may be provided to supplement audio disclosure content. However, if the audio disclosure content is played at a high speed, so will the corresponding closed captioning be, which fails to improve the user's ability to absorb such information. Moreover, sometimes not all disclosure content is presented in audio.

To help solve these problems, systems and methods are provided herein for improved techniques for enhancing deemphasized disclosure content in media. In some embodiments, a UI enhancement application (UIE) is provided for identifying deemphasized content and enhancing its output. In some embodiments, the UIE may provide, for output on a device, a content item comprising a plurality of segments. The UIE may identify one or more attributes associated with at least one of text or audio in at least one segment of the plurality of segments of the content item. The UIE may determine that the one or more attributes indicate an intent to deemphasize the at least one of text or audio of the at least one segment. Based at least in part on determining that the one or more attributes indicate an intent to deemphasize the at least one of text or audio of the at least one segment, the UIE may cause the device to enhance the output of the at least one of text or audio of the at least one segment.

In some embodiments, the UIE may cause the device to enhance the output of the at least one of text or audio of the at least one segment further based at least in part on obtaining user profile data and determining that content of the at least one of text or audio of the at least one segment is relevant to the user profile data.

In some embodiments, the UIE may determine that the one or more attributes indicate an intent to deemphasize the at least one of text or audio further based at least in part on determining that metadata associated with the content item includes one or more keywords indicative of content targeted by the intent to deemphasize the at least one of text or audio of the at least one segment.

In some embodiments, the UIE may determine that the one or more attributes indicate an intent to deemphasize the at least one of text or audio is further based at least in part on identifying a region of text in the at least one segment and determining that the text includes one or more keywords indicative of content targeted by the intent to deemphasize the at least one of text or audio of the at least one segment.

In some embodiments, the UIE may determine that the one or more attributes indicate an intent to deemphasize the at least one of text or audio is further based at least in part on determining that at least a portion of the audio includes one or more keywords indicative of content targeted by the intent to deemphasize the at least one of text or audio of the at least one segment.

In some embodiments, the UIE may determine that the one or more attributes indicate an intent to deemphasize the at least one of text or audio further based at least in part on at least one of a font size or location of the text in the at least one segment.

In some embodiments, the UIE may determine that the one or more attributes indicate an intent to deemphasize the at least one of text or audio by identifying a speech portion of the audio of the at least one segment. The UIE may determine characteristics of the speech portion and characteristics of other content portions of the at least one segment. The UIE may compare the characteristics of the speech portion and the characteristics of the other content portions of the at least one segment. The UIE may determine that a level of similarity between the compared characteristics is below a threshold (e.g., below 50% similarity). In some embodiments, the characteristics comprise at least one of tone, speed, volume, pitch, or sentiment.

In some embodiments, the UIE may determine that the one or more attributes indicate an intent to deemphasize the at least one of text or audio further based at least in part on a duration for which the text or audio is presented in the content item. The duration may be a relative duration with respect to the overall duration of the content item.

In some embodiments, the UIE causes the device to enhance the output of the at least one of text or audio of the at least one segment by transmitting the at least one of text or audio of the at least one segment to a second device, and causing the second device to present the at least one of text or audio of the at least one segment.

In some embodiments, the UIE causes the device to enhance the output of the at least one of text or audio of the at least one segment by at least one: magnifying, highlighting, increasing volume, decreasing speed, or extending duration of the at least one of text or audio of the at least one segment.

In some embodiments, the UIE causes the device to enhance the output of the at least one of text or audio of the at least one segment by obtaining eye tracking data of a user viewing the content item. Based on the eye tracking data, the UIE may identify a location of the content item corresponding to a gaze of the user. The UIE may display the text of the at least one segment at the identified location.

In some embodiments, the UIE may generate metadata based on the content of the at least one of text or audio of the at least one segment relevant to user profile data (e.g., of the user viewing the content item). The UIE may detect, at the device, a user action associated with an object featured in the content item. Based on the detecting, the UIE may cause the device to generate an output based on the metadata. The UIE may cause the device to provide the output at a second time after the first time.

In some embodiments, the UIE may determine that the one or more attributes indicate an intent to deemphasize the at least one of text or audio of the at least one segment by determining that the one or more attributes of the at least one segment are not present in other segments of the plurality of segments.

A benefit of the described systems and methods includes improving the functioning of computers and computer networks in providing important and relevant information within limited screen space, limited screen time, or air time, by enhancing the presentation of information to help a user avoid unnecessarily replaying or storing portions of content that they overlooked due to the portions being deemphasized.

Another benefit includes UI improvements that help direct user attention to important information without disrupting the media item.

Yet another benefit includes helping to reduce inefficient use of computing resources by customizing the UI enhancement of the disclosure content based on user profile data. Such customization reduces the need to output a media item for an unnecessarily long duration in order to present different sets of disclosure content to multiple users, wherein some of the disclosure content is irrelevant to some of those users. For example, by only invoking the enhancement process for content that is relevant to a user (or another user related to the user), and not invoking the enhancement process for content portions that are not relevant to the user (or the other user related to the user), processing resources may be efficiently utilized and conserved.

### BRIEF DESCRIPTION OF THE FIGURES

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example scenario of providing enhancements for deemphasized textual content, in accordance with an embodiment of the disclosure;

FIG. 2 shows another example scenario of providing enhancements for deemphasized audiovisual content, in accordance with an embodiment of the disclosure;

FIG. 3 shows an illustrative user equipment device, in accordance with an embodiment of the disclosure;

FIG. 4 shows an illustrative system, in accordance with an embodiment of the disclosure;

FIG. 5 is a flowchart of an example process for identifying deemphasized textual content, in accordance with an embodiment of the disclosure;

FIG. 6 is a flowchart of another example process for identifying deemphasized textual content, in accordance with an embodiment of the disclosure;

FIG. 7 is a flowchart of an example process for identifying deemphasized audio content in accordance with an embodiment of the disclosure;

FIG. 8 is a flowchart of an example process for identifying deemphasized video content in accordance with an embodiment of the disclosure; and

FIG. 9 is a flowchart of an example process for providing enhancements for deemphasized content, in accordance with an embodiment of the disclosure.

### DETAILED DESCRIPTION

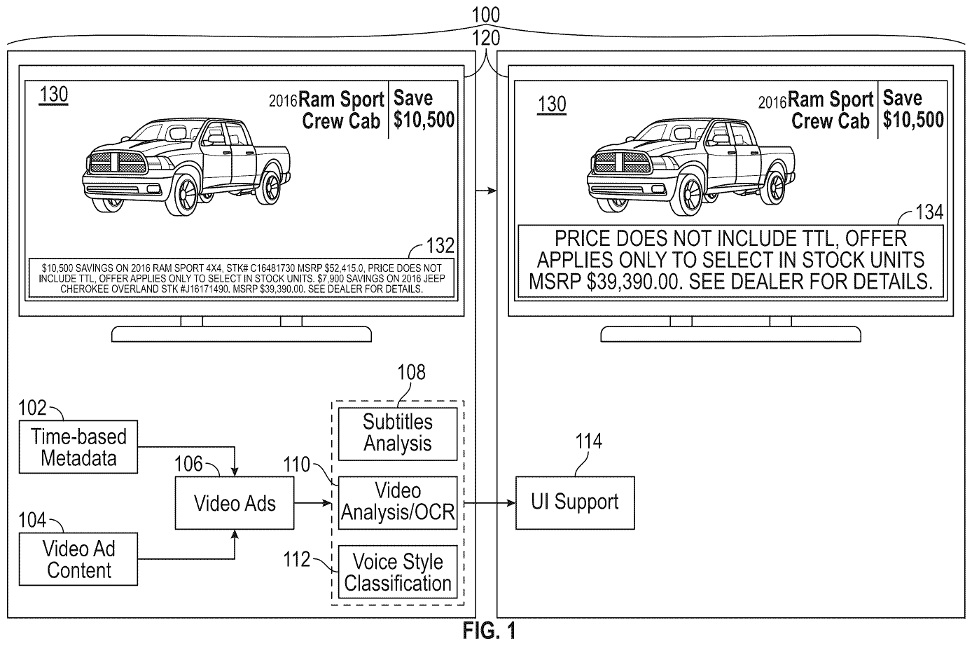

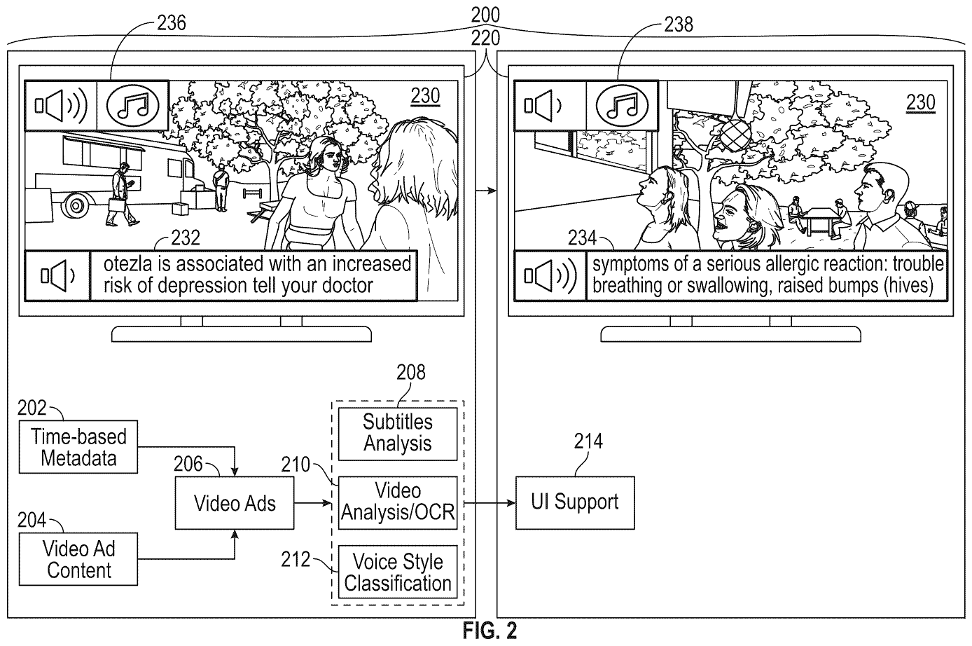

FIG. 1 shows an example scenario 100 of providing enhancements for deemphasized textual content, in accordance with an embodiment of the disclosure. FIG. 2 shows an example scenario 200 of providing enhancements for deemphasized audiovisual content, in accordance with an embodiment of the disclosure. One or more portions of content may include one or more attributes that are indicative of (and/or are targeted by) an intent to deemphasize and/or make inconspicuous such one or more portions of the content. For example, an intent to deemphasize content and/or make content inconspicuous may be based on presenting a portion (e.g., text 132, audio 232) of content in a manner that is different from how one or more other portions of (or the rest of) the content (e.g., content 130, 230) is presented, such as to discourage attention to that portion, to encourage attention to the other portions of (or the rest of) the content, or both. A portion of content may include one or more regions (e.g., of a plurality of regions in an image or a frame of video) and/or a temporal portion (e.g., occurring at one or more timepoints in the duration of a video content item or of an audio content item).

In some embodiments, a UI enhancement application (UIE) is configured to perform functionalities (or any suitable portion of the functionalities) described herein. In the example 100 of FIG. 1, the UIE may provide content 130 for display on device 120. The UIE may be, for example, embedded in a streaming application (e.g., by way of APIs and/or SDKs), or may be a stand-alone application, or may be incorporated in any other suitable platform or application. Content 130 may include disclosure content that is inconspicuous or has been deemphasized in its presentation or output, such as, for example, text 132. In the example, content 130 may be a commercial for a new vehicle and text 132 is fine print disclosing terms and conditions for purchasing the vehicle. Similarly, in example scenario 200 of FIG. 2, content 230 may be a commercial for a pharmaceutical medication and audio 232 is spoken audio narrating warnings and side effects of the medication. Although the examples 100, 200 show content 130, 230, respectively, as advertisements, it is understood that the steps in scenarios 100 and 200 can be implemented using any suitable content, such as, for example, live-streaming content, live broadcast, radio broadcast, subscription-based content, news, political content, on-demand content, video games, announcements, sports games, academic or educational content, conversational content, other suitable audio, visual, or audiovisual content, or any suitable combination thereof. In some embodiments, text 132 or audio 232 is any suitable text or audio, respectively, that includes important information associated with content 130 or 230, respectively. Some illustrative, but non-exhaustive, examples of content 130, 230 may include legal information, representations and warranties, expiration dates, disclaimers, terms and conditions, licensing terms, warnings, information required for compliance with regulations, fees, information verification, or other suitable fine print information that a content provider may have an incentive to deemphasize or make inconspicuous.

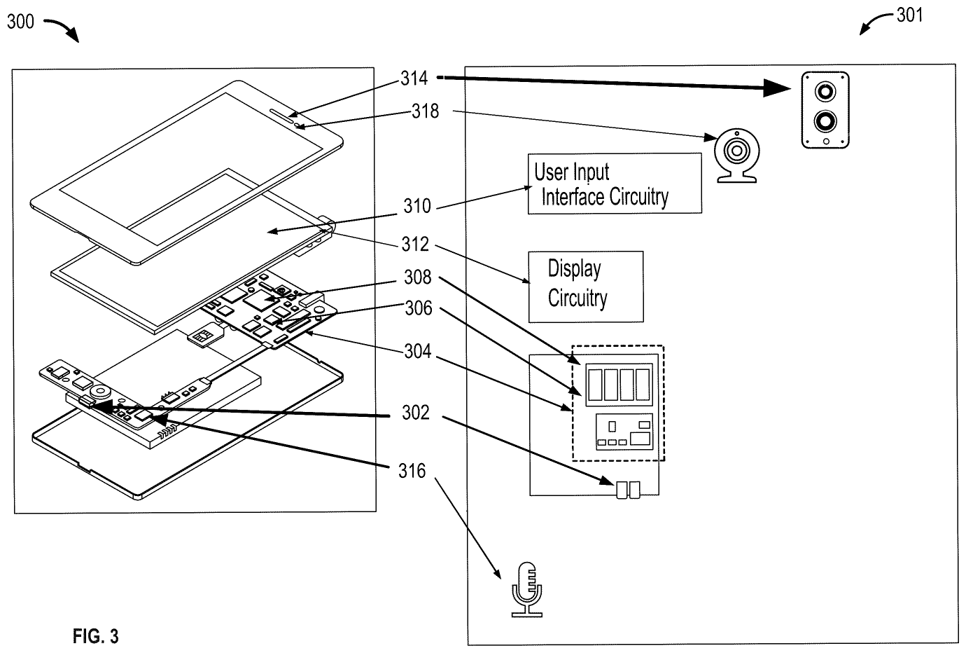

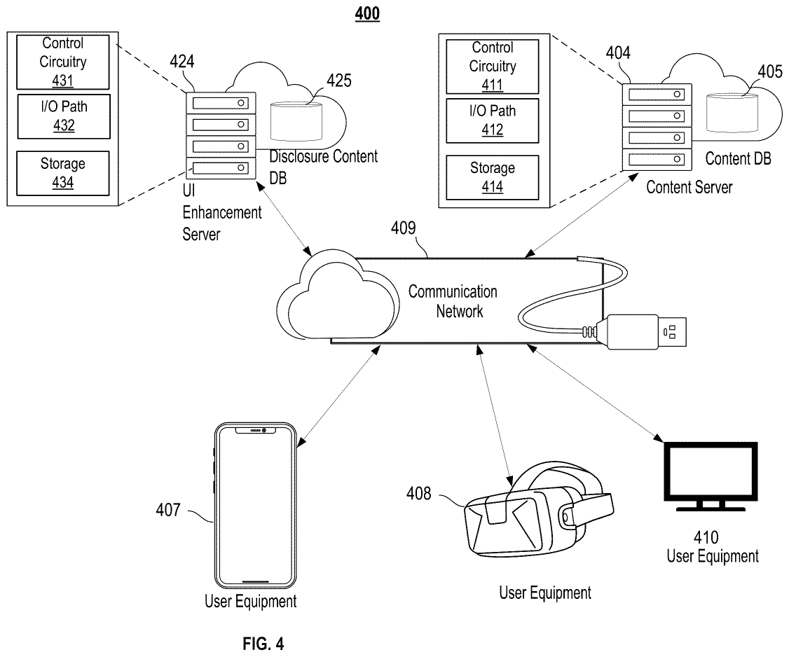

In some examples, the UIE may be executed at least in part at user device 120, 220, user devices 300 or 301 of FIG. 3, databases 405 or 425 of FIG. 4, and/or servers 404 or 424 of FIG. 4, or one or more remote servers, and/or at or distributed across any of one or more other suitable computing devices, in communication over any suitable type of network (e.g., the Internet). In some embodiments, user device 120, 220 may be, for example, a smartphone, a tablet, a handheld device, a laptop, a television set, an XR device such as a head-mounted display (HMD), or any other suitable device capable of presenting audio, textual, visual, and/or audiovisual media.

According to some embodiments, the UIE detects the presence of text (e.g., text 132), audio (e.g., 232), or both, within the content (e.g., content 130, 230). For example, referring to FIG. 1, at step 102, the UIE may detect the presence of text 132 based on metadata or supplemental files associated with content 130 (e.g., portions of closed captioning files, such as SubRip (SRT) files or web video text tracks (VTT) files, that correspond to text 132, or other metadata, e.g., inserted by the content provider or inserted based on analysis of the content, which may occur before the content is presented or while the content is presented). An example pseudocode of such metadata is shown below.

```
{
  “fine_print”: [
  {
    “start_time”: “00:00:25”,
    “end_time”: “00:00:28”,
    “text”: “Terms and conditions apply. Offer valid only for new
    customers.”,
    “font_size”: “small”,
    “position”: “bottom”,
    “actions”: [
      {
        “type”: “highlight”,
        “color”: “yellow”
      },
      {
        “type”: “zoom”,
        “scale”: 1.5
        }
      ]
    }
  ]
}
```

In the example pseudocode, the metadata may include text corresponding to text 132 (e.g., comprising keywords that a content provider may have an incentive to deemphasize, such as “terms and conditions” and “offer valid only for”). Text 132 may be configured to be displayed for a particular time starting a particular timestamp (e.g., between the 25-second mark to the 28-second mark). The metadata may specify other attributes of text 132 that make it less likely to draw a user's attention, such as a small font size and positioning the text at the bottom of the frame.

In some embodiments, such as at step 104, the UIE detects the presence of text 132 based on analysis of content 130 itself. For example, the UIE may detect text 132 based on image recognition of text occurring in various regions of frames of content 130. For instance, at step 106 of FIG. 1, the UIE may divide the video stream of content 130 into individual frames at a configurable rate (e.g., such that the frames can be analyzed with sufficient granularity to capture text 132). The UIE may scan (e.g., using computer vision or other imaging models) each frame to detect regions that likely contain text based on pixel patterns, edge detection, pre-trained machine learning models, other suitable models, or a combination thereof. At step 110 of FIG. 1, the UIE may then implement optical character recognition (OCR) or other suitable imaging techniques to extract the content of text 132 by converting the image regions into machine-readable text.

For instance, referring to FIG. 2, at step 202, the UIE may detect the presence of audio 232 based on metadata or supplemental files associated with content 230 (e.g., portions of closed captioning files, such as SRT or VTT files, that correspond to the audio 232). In some embodiments, such as in step 204, the UIE may detect audio 232 based on analysis of content 230. For example, at step 206, the UIE may divide the video stream of content 230 into individual frames and perform audio analysis (e.g., audio source separation) of the frames. For instance, the UIE may separate the spoken audio (e.g., audio 232) from background music 236. At step 212 of FIG. 2, the UIE may perform natural language processing (NLP) or other suitable language processing model to extract the content of audio 232.

According to some embodiments, the UIE analyzes various attributes of the detected text and/or audio and determines whether the attributes indicate that text 132 and/or audio 232 includes content that has been deemphasized by the content provider (or is associated with one or more attributes indicative of an intent to deemphasize). Attributes may include, for example, UI-based attributes, content-based attributes, contextual attributes, other suitable attributes, or a combination thereof. For example, UI-based attributes may include font style or size (e.g., with respect to other text or images displayed in the same frame), color, opacity, location of the text (e.g., position with respect to a frame of content 130), speed in which the text or audio is presented, the duration for which the text or audio is presented, volume, pitch, or any other suitable attributes, or any suitable combination thereof, relating to UI features of the text portions, visual objects or other visual portions, or audio portions of the content. In some examples, the UIE may compare these attributes to a particular threshold (e.g., compare volume of spoken audio 232 against a particular volume level) or against the same attributes of other portions of the content 130, 230 (e.g., compare volume of spoken audio 232 against volume of background music 236), to determine whether the portion(s) of the content having the attributes are intended by the content provider to be deemphasized.

For instance, referring to FIG. 1, at step 108, the UIE may determine that text 132 is displayed for a brief duration (e.g., 10 seconds compared to the entire 60 second duration of content 130) based on the number of consecutive (or non-consecutive) frames in which text 132 appears. In another instance, the UIE may determine the duration based on metadata (e.g., the corresponding subtitle file may include timestamps describing when text 132 is presented). At step 110, the UIE may also determine that text 132 is presented in small font (e.g., compared to a size threshold, such as 15-20 mm in height as displayed on a 4K television set, or compared to the size of other text conveying the name of the vehicle and cost savings) and is positioned at the bottom of the frame (or other portion of the frame that is generally intended to be inconspicuous, or in the context of the particular frame being displayed, may be intended to be inconspicuous). The UIE may determine that, based on its short display duration, small font, and low positioning, text 132 is likely being output in a manner that is intended to deemphasize text 132.

For instance, referring to FIG. 2, at step 208, the UIE may determine that audio 232 is presented for a brief duration based on the number of consecutive frames in which audio 232 is provided. In another instance, the UIE may determine the duration based on metadata (e.g., the corresponding subtitle file may include timestamps describing when closed captioning corresponding to the audio 232 is presented). At step 210, the UIE may also determine that audio 232 is presented with low volume and low pitch, compared to the high volume and high pitch of background music 236. The UIE may further determine that audio 232 has a high speech rate compared to a threshold speech rate (e.g., 100-160 words per minute). Based on its short presentation duration, low volume and pitch, and high speech rate, the UIE may determine that audio 232 is likely being output in a manner that is intended to deemphasize audio 232.

Content-based attributes may include keywords or phrases in the deemphasized content, tone or sentiment associated with the deemphasized content, or other suitable attributes relating to the content or context of the text or audio. The UIE may identify the keywords, tone, sentiment, or other such attributes by implementing natural language processing (NLP), and/or other suitable language processing model, on the text or audio. In some examples, keywords or phrases commonly used in fine print may include terms such as, for example, “terms and conditions apply,” “side effects include,” and “limited-time offer.” Keywords or phrases may additionally or alternatively include language indicating fees, dates, warnings, domain-specific terminologies, and/or other suitable information. In some embodiments, whether certain terms are considered keywords or phrases may be based on the context or type of content of content 130, 230. For instance, some terms may have little significance (e.g., not considered keywords) with respect to content 130 if the content is a commercial for purchasing a vehicle, but those same keywords may have high significance (e.g., would be considered keywords) if content 130 is a political announcement. Such terms may be stored in a database or other datastore for reference, and may be added to the databased or datastore as likely to be indicative of fine print by manual curators and/or based at least in part on computer-implemented techniques, e.g., one or more machine learning models trained to recognize text, audio, or other content indicative of an intent to deemphasize or obfuscate, in relation to other portions of the content.

In some embodiments, the tone or sentiment of text 132 or audio 232 is determined based on the presence of certain terms, linguistic style, visual presentation style, pitch, inflection, volume, speed, or other suitable features of text 132 or audio 232. For instance, the terms “serious side effects” may indicate a serious tone or negative sentiment, and therefore may be more likely to include content targeted by an intent to deemphasize. The UIE may compare the tone or sentiment of text 132 or audio 232 with that of other portions of content 130 or 230, respectively.

For instance, referring to FIG. 1, at step 112, the UIE may determine that text 132 includes transactional terms (e.g., fees or expiration date) and has a formal linguistic style, indicating a transactional sentiment. Meanwhile, the rest of content 130 may include a shiny image of a brand-new vehicle and large text describing the name of the vehicle model and monetary savings in a promotional linguistic style, indicating an exciting sentiment. Based on the contrasting sentiments between text 132 and the rest of content 130, the UIE may determine that text 132 is more likely to include content targeted by an intent to deemphasize the content.

For instance, referring to FIG. 2, at step 212, the UIE may determine that audio 232 includes medical terms (e.g., side effects) and has a clinical linguistic style, indicating a serious and negative sentiment. Meanwhile, the rest of content 230 may include upbeat background music 236 and images of people smiling and dancing, indicating an upbeat and positive sentiment. Based on the contrasting sentiments between audio 232 and the rest of content 230, the UIE may determine that audio 232 is more likely to include content targeted by an intent to deemphasize.

In some embodiments, the UIE may calculate an importance score associated with text or audio to determine whether the text or audio includes content targeted by an intent to deemphasize. In some examples, if the importance score of the text or audio is above an importance threshold, the UIE may determine that the text or audio includes content targeted by an intent to deemphasize the content. In other examples, the UIE may calculate a respective importance score for multiple portions of text or audio of content 130, 230. The UIE may rank each importance score and determine that the text or audio portion with the highest importance score includes content targeted by an intent to deemphasize. By ranking the importance scores of various portions of the content, the UIE may be able to distinguish between disclosure content and background content.

The importance score may be calculated based on combining respective scores associated with various attributes of the text or audio. For example, the UIE may calculate for text 132 or audio 232 a font size score, text position score, keyword match score, display duration score, volume score, speed or speech rate score, pitch score, sentiment dissimilarity score (e.g., between the text or audio and the rest of the content), other suitable confidence scores, or a combination thereof. For instance, a smaller font size may correspond with a higher font size score. A shorter display duration may correspond with a higher display duration score. A higher dissimilarity between the sentiment of text 132 and the sentiment of the rest of content 130 may correspond with a higher sentiment dissimilarity score. In some embodiments, the various component scores of the importance score may be assigned various weights. For instance, the keyword match score may have more weight toward the calculation of the importance score than does the sentiment dissimilarity score. Further, some keywords may have higher weight than other keywords (e.g., based on the type of content 130, 230). For instance, a keyword such as “fees” may not be as important as “offer cannot be combined with” or “expiration date” in a promotion for the sale of a new vehicle.

Additionally, or alternatively, the importance score may be calculated based on relevance of text 132 (or audio 232) with respect to user profile data of a user associated with device 120 viewing content 130 (e.g., a user relevance score). For example, the user may have previously demonstrated interest in purchasing a new vehicle (e.g., by way of user's web search history) or outdoor recreational activities, or the user may work in construction. Because text 132 has higher relevance to the user profile data, the UIE may calculate a higher importance score for text 132. In another example, the user profile data may indicate that the user is not licensed to operate vehicles like the one portrayed in content 130 or that they live in an area where owning a vehicle is uncommon. Therefore, text 132 may have lower relevance to the user profile data, and the UIE may calculate a lower importance score for text 132. In some embodiments, the UIE may also determine the relevance of text 132 to user profile data of other people associated with the user, such as the user's spouse or members of the user's household.

In some embodiments, the UIE performs the importance analysis, or a different analysis, across different versions of content 130. For example, there may be a 1-minute version, a 30-second version, and a 10-second version of content 130. In another example, there may be a different sale price or vehicle model listed in different versions of content 130 directed to different geographic locations (e.g., different states) or provided during different times of the year (e.g., seasons or holidays). The variable feature across the different versions, such as the overall duration of content 130, may provide information for the UIE to determine whether text 132 includes content targeted by an intent to deemphasize. The variable feature may also be used in in calculating the importance score of text 132. For instance, if content 130 is 10 seconds long, the UIE may calculate the importance score of text 132 based on its font size and position but not on its display duration (or its display duration may have less weight than its other attributes), due to the shortness of the overall content 130 duration. Meanwhile, the UIE may consider (or increase the weight of) display duration of text 132 in addition to its font size and position if the overall content 130 duration is longer (such as 1 minute).

According to some embodiments, the UIE automatically enhances the output of text 132 or audio 232 based on determining that text 132 or audio 232 includes content that has been deemphasized or has one or more attributes indicative of an intent to deemphasize. In some embodiments, the UIE performs the enhancement further based on determining whether text 132 or audio 232 is relevant to a user (or an associated user, such as, for example, a spouse or child) associated with device 120 viewing content 130 or content 230, respectively.

For instance, referring to FIG. 1, if the user (or an associated user, such as a spouse) demonstrates interest in purchasing a new vehicle, then the UIE may determine that text 132 (e.g., containing terms and conditions for purchasing the vehicle) is relevant to the user and may enhance the UI of text 132 as displayed on device 120. In contrast, if user profile data indicates that the user is not interested in purchasing a new vehicle, then the UIE may determine that text 132 is not relevant to the user and may refrain from enhancing the output of text 132.

For instance, referring to FIG. 2, if the user is diabetic or is at risk of having diabetes, and the audio 232 mentions a medical risk for people with diabetes who take the medication, then the UIE may determine that audio 132 is relevant to the user and may enhance its output. In another instance, the audio 232 may mention a risk for patients who are pregnant. If the UIE determines that while the user is not pregnant but the wife of the user is pregnant or plans to become pregnant, then the UIE may determine that audio 232 is relevant to the user and may enhance the output of audio 232 as provided on device 220. For example, the UIE may learn that the user or their spouse is pregnant based on analyzing calendar data for doctor's appointments, text messages, emails, direct input from the user, web activity, application, or any other suitable activity.

In some embodiments, the UIE may calculate a user relevance score for text 132 of audio 232. If the relevance score is above a particular relevance threshold, or if the user relevance score of text 132 or audio 232 ranks the highest among relevance scores associated with other portions of content 130 or 230, respectively, then the UIE may enhance the output of text 132 or audio 232.

The UIE may perform various enhancements of the output of deemphasized content. Such modifications of the output may include enhancements that help make the deemphasized content more likely to capture the user's attention and/or easier for the user to consume or comprehend. For example, the UIE may enlarge, highlight, magnify, change location, slow down the presentation (e.g., extend duration), increase the volume, modify the audio mixing, or perform other suitable enhancements, or perform a combination thereof. In another example, a visual object, e.g., other than text, may include attributes indicative of an intent to deemphasize. For example, if, in the content being output, a white cloud overlaps with white text, this may make it difficult for a user to read such text. In this example, the UIE may modify one or more attributes (e.g., color or position on the screen) of the cloud and/or text, to make the text more legible.

In some examples, the UIE may bookmark frames or segments corresponding to text 132 or audio 232, allowing a user to revisit the bookmarked frames.

In some examples, the UIE may modify the content of enhanced text 134 or enhanced audio 234 such that they include terminologies, explanations, and/or examples that are easier for the user to understand. For instance, if text 132 or audio 232 is filled with domain-specific terminologies, such as complex legal terms or medical terms, the UIE may replace the language with common terms. In another instance, if content 130 or 230 includes misinformation, the UIE may add language with verified (e.g., fact-checked) information to enhanced text 134 or enhanced audio 234. For example, the UIE may identify and output synonyms of domain-specific terms and/or a rephrasing of the output text or audio (e.g., obtained using a thesaurus or NLP model) more easily understandable by a lay person, e.g., in relation to a pharmaceutical advertisement. In some examples, the modified text may be a summary or other suitable reduction or paraphrasing of terms in text 132, such that modified text 134 can be displayed within the size of the original text box (e.g., text 132) but with a larger font size, or be played at a slower speed within the same total length of the original audio or video of content 130. In another embodiment, an example scenario and outcome may be included, for instance, the example of accepting arbitration and/or venue conditions may potentially bind the user to arbitrate a cause of action that is seemingly unrelated, or to limit venue to a particular jurisdiction.

In some examples, the UIE may provide UI elements with the display of content 130, 230, that allows the user to interact with text 132 or audio 232, respectively. For example, enhanced text 134 may include UI elements that provide explanations when a cursor hovers over keywords. In another example, the UI elements may provide supplemental information such as fact-checked verification of the content 130, 230. In some examples, the UIE may provide a push notification (e.g., to device 120, 220 or another device associated with the same user profile) or other suitable selectable option such that when selected, the push notification may provide more details of the deemphasized content.

In some examples, the UIE may additionally or alternatively cause a second device (not shown), such as a smartphone or tablet, to provide the enhanced text 134 or enhanced audio 234. In some instances, the UIE may automatically cause the second device to provide the enhanced output. In other instances, the UIE may provide a user selectable option or other suitable UI element for the user to select which device to be the second device and/or to confirm to have the enhanced output provided by the selected second device.

In some examples, the UIE may use eye-tracking models to determine where the user's focus is during or with respect to the content. The UIE may adjust various elements within the content in real time to guide the user's attention toward text 132 or images associated with content of audio 232. For instance, if the eye-tracking data indicates that the user is more likely to gaze at the center of the screen, the UIE may reposition text 132 toward that region. In another instance, the UIE may introduce a UI element located close to text 132, such as a flashing or bright image, to draw the user's attention toward text 132.

For instance, referring to FIG. 1, at step 114, the UIE may magnify text 132 and display the enhanced text 134 over content 130, such as via a side window or overlaid on the video in a transparent box. The UIE may extend the display duration of text 132, increase font size or change the font type to a more legible font. The UIE may implement text-to-speech models to read text 132 aloud. The UIE may adjust the contrast, color, opacity, or other suitable properties of text 132, to make enhanced text 134 more visually prominent. The UIE may modify attributes of the rest of content 130 to more closely match the sentiment of text 132. For instance, the UIE may slow down or tone down the brightness of visual elements surrounding text 132, such that the sentiment of the rest of content 130 more closely matches the sentiment of text 132.

For instance, referring to FIG. 2, at step 214, the UIE may modify the audio 232 to be more coherent. For instance, if the audio 232 is mumbled or indistinct, the UIE may increase its volume and slow its speech rate. If the audio 232 is output loudly such that it becomes incoherent, the UIE may decrease the volume and slow its speech rate. In some examples, the UIE may modify the audio mixing of content 230. For instance, the UIE may increase the volume of audio 232 while decreasing volume of background music 236. The UIE may slow the speech rate or extend presentation duration of audio 232, making enhanced audio 234 easier to hear over modified background music 238. The UIE may implement NLP to audio 232 and add corresponding captions to the display. The UIE may modify attributes of other portions of content 230 to more closely match the sentiment of audio 232. For instance, the UIE may slow down or tone down the brightness or saturation of the visual portions of content 230, or lower the pitch and volume of background music 236, to increase the serious sentiment of the overall content 230 to more closely match the serious sentiment of audio 232.

According to some embodiments, the UIE automatically enhances the output of text 132 or audio 232 upon determining that they are deemphasized content. In some instances, the UIE may determine, based on metadata of the content, the time that the text 132 or audio 232 will appear and automatically activate the output enhancement at that time.

Additionally, or alternatively, the UIE may present the text 132 or audio 232 (or enhanced text 134 or enhanced audio 234) at a later time. For example, the UIE may determine that text 132 or audio 232 is relevant, or could possibly be relevant sometime in the future, to the user. The UIE may generate metadata associated with the segments corresponding to the text 132 or audio 232 that is relevant to the user and store that metadata. When the user performs an action relating to the content at a later time (e.g., makes, or is about to make, an e-commerce purchase of the vehicle promoted in content 130), the UIE may generate, based on the metadata, supplemental content associated with text 132 (e.g., a notification describing the terms and conditions from text 132). For instance, the UIE may provide the supplemental content at the time of purchase (e.g., via a pop-up window). In some embodiments, if terms and conditions indicate that an offer or coupon is only valid until a certain date, the UIE may provide a reminder on or before such date, to enable a user to take advantage of the offer or coupon.

In some examples, the text 132 or audio 232 may not be relevant to the user or associated user (e.g., spouse) during the first time the content 130, 230 is presented, but may become relevant at a later time. For instance, when viewing content 230, the audio 232 may list health risks for patients who are pregnant. The user's spouse may not be pregnant during the first time that content 230 is presented, and so the UIE may refrain from enhancing the output of audio 232 at that time. However, when the user orders the prescription medication described in content 230 at a second time (e.g., 3 months later), the user profile data of the user's spouse may indicate that the spouse has become, or plans to become, pregnant. Because the audio 232 is now relevant to the associated user, the UIE may present supplemental content associated with audio 232 (e.g., a text or audio notification listing the medical risks and side effects from audio 232) at the time the user fills the prescription.

In some embodiments, the UIE provides controllable UI elements that allows the user to customize the output enhancements of detected deemphasized content. For example, the UIE may provide a UI element that can be toggled by the user to activate one or more of the aforementioned output enhancements.

In some embodiments, the UIE automatically personalizes enhancements of deemphasized content with user profile data, such as user preferences or historical user activity. For instance, if a user prefers to consume important information through supplemental text provided on a separate (e.g., second) device, the UIE may cause a smartphone of the user to display the contents of text 132 (such as by way of a push notification) while the user views the content 130 unmodified on their television.

FIGS. 3-4 depict illustrative devices, systems, servers, and related hardware for modifying displayed content based on a saccade of a user, in accordance with some embodiments of this disclosure. FIG. 3 shows generalized embodiments of illustrative user equipment devices 300 and 301, which may correspond to any of the above-described user devices (e.g., user device 120, 220). In some embodiments, user equipment device 300, 301 is a smartphone device, a tablet, an XR device such as a head-mounted display (HMD), or any other suitable device capable of displaying XR content, smart TV, IoT device, smart assistant device or home assistant device, a camera device or any other suitable computing device, a network-based server hosting a user-accessible client device, a non-user-owned device, any other suitable device, or any combination thereof. Each of user equipment device 300, 301 is communicatively connected to at least one of microphone 316, audio input equipment, camera 318, display circuitry 312, and user input interface circuitry 310. For example, display 312 may be a computer display, a 3D display (such as, for example, a tensor display, a light field display, a volumetric display, a multi-layer display, an LCD display or any other suitable type of display, or any combination thereof). For example, user input interface 310 may be a remote-control device.

In some embodiments, each one of user equipment device 300, 301 receives content and data via input/output (I/O) path (e.g., circuitry) 302. I/O path 302 provides data to control circuitry 304, which comprises processing circuitry 306 and storage 308. Control circuitry 304 is used to send and receive commands, requests, and other suitable data using I/O path 302, which comprises I/O circuitry. I/O path 302 connects control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable control circuitry such as processing circuitry 306. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for the UIE or other suitable application stored in memory (e.g., storage 308). Specifically, control circuitry 304 may be instructed by the UIE to perform the functions discussed above and below. In some implementations, processing or actions performed by control circuitry 304 may be based on instructions received from the UIE or other suitable application or platform.

In some client/server-based embodiments, control circuitry 304 may include communications circuitry suitable for communicating with a server or other networks or servers. The UIE is a stand-alone application implemented on a device or a server. The UIE may be implemented as software or a set of executable instructions. The instructions for performing any of the embodiments discussed herein of the UIE may be encoded on non-transitory computer-readable media (e.g., a hard drive, random-access memory on a DRAM integrated circuit, read-only memory on a BLU-RAY disk, etc.). For example, in FIG. 3, the instructions may be stored in storage 308, and executed by control circuitry 304 of a device 300, 301.

In some embodiments, the UIE is a client/server application where only the client application resides on device 300, 301 and a server application resides on an external server (e.g., server 404, 424). For example, the UIE may be implemented partially as a client application on control circuitry 304 of device 300, 301 and partially on server 404, 424 as a server application running on control circuitry 411, 431, respectively. Server 404, 424 may be a part of a local area network with one or more of devices 300, 301 or may be part of a cloud computing environment accessed via the internet. In a cloud computing environment, various types of computing services for performing searches on the internet or informational databases, providing encoding/decoding capabilities, providing storage (e.g., for a database) or parsing data (e.g., using machine learning algorithms described above and below) are provided by a collection of network-accessible computing and storage resources (e.g., server 404, 424), referred to as “the cloud.” Device 300, 301 may be a cloud client that relies on the cloud computing capabilities from server 404, 424 to receive and process encoded data. When executed by control circuitry of server 404, 424 the UIE instructs control circuitry 411, 431, respectively, to perform processing tasks for the client device.

Control circuitry 304 may include communications circuitry suitable for communicating with a server, edge computing systems and devices, a table or database server, or other networks or servers. The instructions for carrying out the above-mentioned functionality may be stored on a server (which is described in more detail in connection with FIG. 4). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media application and/or gaze mapping application data described above. Nonvolatile memory may also be used (e.g., to launch a boot-up routine and other instructions). Cloud-based storage, described in relation to FIG. 3, may be used to supplement storage 308 or instead of storage 308.

Control circuitry 304 may include video generating circuitry and tuning circuitry, such as one or more analog tuners, one or more H.265 decoders or any other suitable digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of user equipment 300, 301. Control circuitry 304 may also include digital-to-analog converter circuitry and analog-to-digital converter circuitry for converting between digital and analog signals. The tuning and encoding circuitry may be used by user equipment device 300, 301 to receive and to display, to play, or to record content. The tuning and encoding circuitry may also be used to receive video encoding/decoding data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment device 300, the tuning and encoding circuitry (including multiple tuners) may be associated with storage 308.

Control circuitry 304 may receive instruction from a user by way of user input interface circuitry 310. User input circuitry 310 may be any suitable user interface circuitry, such as a remote control, mouse, trackball, keypad, keyboard, touch screen, touchpad, stylus input, joystick, voice recognition interface, or other user input interfaces. Display circuitry 312 may be provided as a stand-alone device or integrated with other elements of each one of user equipment device 300, 301. For example, display circuitry 312 may be a touchscreen or touch-sensitive display. In such circumstances, user input interface circuitry 310 may be integrated with or combined with display circuitry 312. In some embodiments, user input interface circuitry 310 includes a remote-control device having one or more microphones, buttons, keypads, any other components configured to receive user input or combinations thereof. For example, user input interface circuitry 310 may include a handheld remote-control device having an alphanumeric keypad and option buttons.

Audio output equipment 314 may be integrated with or combined with display circuitry 312. Display circuitry 312 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display circuitry 312. Audio output equipment 314 may be provided as integrated with other elements of each one of device 300 and equipment 301 or may be stand-alone units. An audio component of videos and other content displayed on display circuitry 312 may be played through speakers (or headphones) of audio output equipment 314. In some embodiments, audio may be distributed to a receiver (not shown), which processes and outputs the audio via speakers of audio output equipment 314. In some embodiments, for example, control circuitry 304 is configured to provide audio cues to a user, or other audio feedback to a user, using speakers of audio output equipment 314. There may be a separate microphone 316 or audio output equipment 314 may include a microphone configured to receive audio input such as voice commands or speech. For example, a user may speak letters or words that are received by the microphone and converted to text by control circuitry 304. In a further example, a user may voice commands that are received by a microphone and recognized by control circuitry 304. Camera 318 may be any suitable video camera integrated with the equipment or externally connected. Camera 318 may be a digital camera comprising a charge-coupled device (CCD) and/or a complementary metal-oxide semiconductor (CMOS) image sensor. Camera 318 may be an analog camera that converts to digital images via a video card.

The UIE may be implemented using any suitable architecture. For example, it may be a stand-alone application wholly-implemented on each one of user equipment device 300 and user equipment device 301. In such an approach, instructions of the application may be stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to provide encoding/decoding functionality and preform any of the actions discussed herein. Based on the processed instructions, control circuitry 304 may determine what action to perform when input is received from user input interface circuitry 310. For example, movement of a cursor on a display up/down may be indicated by the processed instructions when user input interface circuitry 310 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the UIE is a client/server-based application. Data for use by a thick or thin client implemented on each one of user equipment device 300 and user equipment device 301 may be retrieved on-demand by issuing requests to a server remote to each one of user equipment device 300 and user equipment device 301. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on device 300, 301. This way, the processing of the instructions is performed remotely by the server while the resulting displays (e.g., that may include text, a keyboard, or other visuals) are provided locally on device 300, 301. Device 300, 301 may receive inputs from the user via input interface circuitry 310 and transmit those inputs to the remote server for processing and generating the corresponding displays. For example, device 300, 301 may transmit a communication to the remote server indicating that an up/down button was selected via input interface circuitry 310. The remote server may process instructions in accordance with that input and generate a display of the application corresponding to the input (e.g., a display that moves a cursor up/down). The generated display is then transmitted to device 300, 301 for presentation to the user.

In some embodiments, the UIE may be downloaded and interpreted or otherwise run by an interpreter or virtual machine (run by control circuitry 304). In some embodiments, the UIE may be encoded in the ETV Binary Interchange Format (EBIF), received by control circuitry 304 as part of a suitable feed, and interpreted by a user agent running on control circuitry 304. For example, the media application and/or gaze mapping application may be an EBIF application. In some embodiments, the UIE may be defined by a series of JAVA-based files that are received and run by a local virtual machine or other suitable middleware executed by control circuitry 404. In some of such embodiments (e.g., those employing MPEG-2 or other digital media encoding schemes), the UIE may be, for example, encoded and transmitted in an MPEG-2 object carousel with the MPEG audio and video packets of a program.

FIG. 4 is a diagram of an illustrative system 400, in accordance with some embodiments of this disclosure. System 400 may comprise user equipment devices 407, 408, 410 and/or any other suitable number and types of user equipment, networking equipment capable of transmitting data by way of communication network 409. User equipment devices 407, 408, 410 may comprise a smartphone device, a tablet, XR device or any other suitable device capable of processing XR content, smart TV, IoT device, smart assistant device or home assistant device, a camera device or any other suitable computing device, a network-based server hosting a user-accessible client device, a non-user-owned device, any other suitable device, or any combination thereof. Communication network 409 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 409) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 4 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 409.

System 400 may comprise content data source 405, saccades data source 425, and/or one or more servers 404, 424. In some embodiments, the UIE may be executed at one or more of control circuitry 411, 431 of servers 404, 424 respectively (and/or control circuitry of user equipment devices 407, 408, 410).

In some embodiments, servers 404, 424 include control circuitry 411, 431 and storage 414, 434 (e.g., RAM, ROM, Hard Disk, Removable Disk, etc.), respectively. Storage 414, 434 may store one or more databases. Server 404, 424 may also include an input/output path 412, 432, respectively. I/O path 412, 432 may provide encoding/decoding data, device information, or other data, over a local area network (LAN) or wide area network (WAN), and/or other content and data to control circuitry 411, 431, which may include processing circuitry, and storage 414, 434, respectively. Control circuitry 411, 431 may be used to send and receive commands, requests, and other suitable data using I/O path 412, 432, respectively, which may comprise I/O circuitry. I/O path 412, 432 may connect control circuitry 411, 431, respectively (and specifically control circuitry) to one or more communications paths.

Control circuitry 411, 431 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 411, 431 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 411, 431 executes instructions for an emulation system application stored in memory (e.g., the storage 414, 434, respectively). Memory may be an electronic storage device provided as storage 414, 434 that is part of control circuitry 411, 431, respectively.

Content data source 405, saccades data source 425, servers 404, 424, or any combination thereof, may include an encoder. Such encoder may comprise any suitable combination of hardware and/or software configured to process data to reduce storage space required to store the data and/or bandwidth required to transmit the image data, while minimizing the impact of the encoding on the quality of the media content being encoded. In some embodiments, the data to be compressed may comprise a raw, uncompressed 3D media content, or 3D media content in any other suitable format. In some embodiments, each of user equipment devices 407, 408, 410 may receive encoded or encoded data locally or over a communication network (e.g., communication network 409 of FIG. 4) and may comprise one or more decoders. Such decoder may comprise any suitable combination of hardware and/or software configured to convert data in a coded form to a form that is usable as video signals and/or audio signals or any other suitable type of data signal, or any combination thereof. User equipment devices 407, 408, 410 may be provided with encoded data. In some embodiments, at least a portion of decoding may be performed remote from user equipment devices 407, 408, 410.

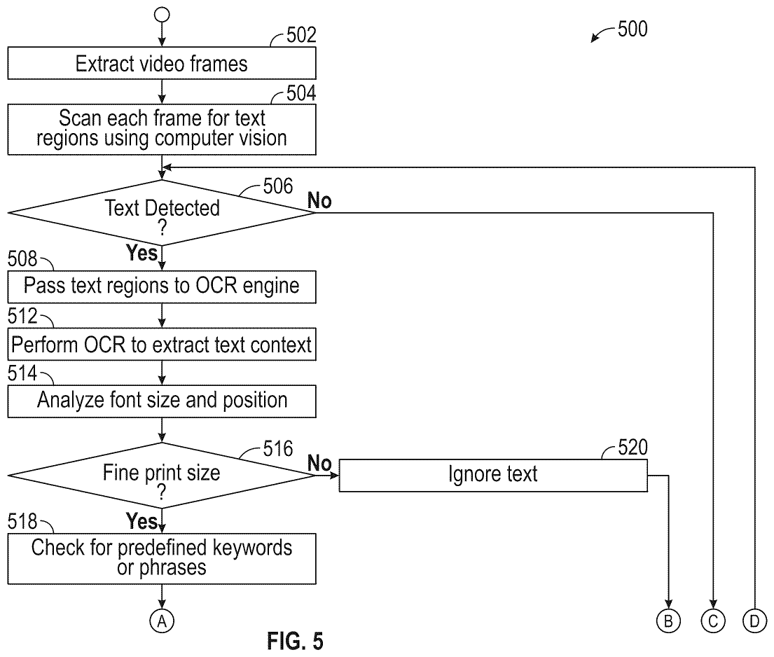

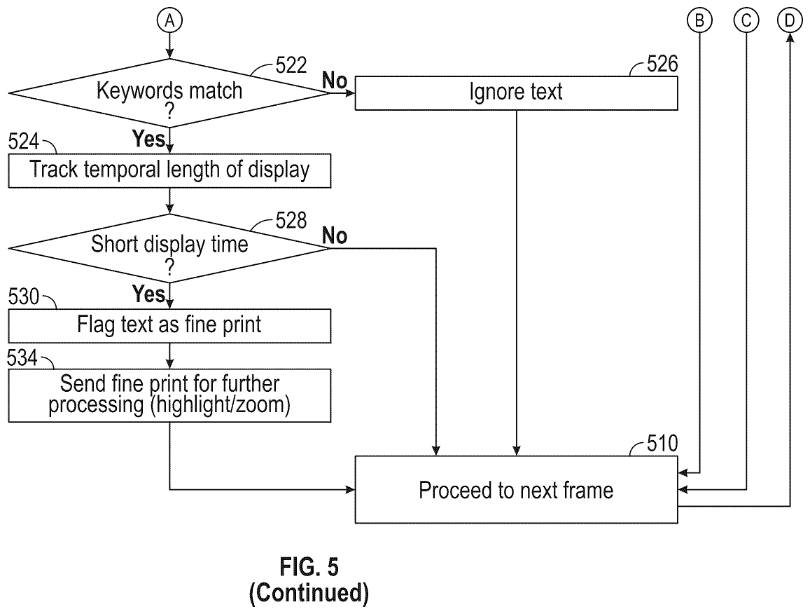

FIGS. 5-9 are system sequence diagrams and flowcharts of various processes 500-900, respectively. In various embodiments, the individual steps of each process 500-900 may be implemented by one or more components of the devices and systems of FIGS. 3-4. Although the present disclosure may describe certain steps of each process 500-900 (and of other processes described herein) as being implemented by certain components of the devices and systems of FIGS. 3-4, this is for purposes of illustration only, and it should be understood that other components of the devices and systems of FIGS. 3-4 may implement those steps instead. For example, the steps of each process 500-900 may be executed by server 404, 424 and/or by user equipment device 407, 408, 410 and/or by control circuitry 304 of a device 300, 301 and/or by control circuitry 411, 431 for modifying displayed content based on eye tracking data of the user.

FIG. 5 is a flowchart of an example process 500 for identifying deemphasized textual content, in accordance with an embodiment of the disclosure. In some embodiments, at step 502, control circuitry 431 (e.g., of UI enhancement server 424) extracts one or more video frames of content (e.g., content 130 of FIG. 1 or content 230 of FIG. 2). Although video frames are shown in the example, it is understood that the process may be implemented for any other suitable content, including audio, textual, image, or audiovisual content.

At step 504, control circuitry 431 may scan each frame for text regions. For instance, control circuitry 431 may use computer vision or other suitable image processing models to detect regions containing textual content.

At step 506, if control circuitry 431 detects text in a region of a frame, then, at steps 508 and 512, control circuitry 431 may extract the text (e.g., by way of OCR or other suitable models for converting the regions into machine-readable text). If control circuitry 431 does not detect text in the region, then control circuitry 431 may determine that the frame does not include content that has been deemphasized and/or targeted by an intent to deemphasize, and may proceed to step 510 and perform text detection in the next frame.

At step 514, control circuitry 431 may analyze one or more attributes of the text as presented, such as its font, font size, position within the frame, other suitable output attributes (such as UI-related attributes), or a combination thereof.

At step 516, if control circuitry 431 determines that one or more the attributes of the detected text meets one or more criteria (e.g., the font is smaller than a particular font size), then, at step 518, control circuitry 431 may proceed to analyze the content or context of the text. For instance, control circuitry 431 may determine whether the text contains one or more predefined keywords or phrases. However, if control circuitry 431 determines that the text does not meet the criteria (e.g., the font size is at or above a particular font size), then, at step 520, control circuitry 431 may ignore the text (e.g., classify the text as not including content that has been deemphasized and/or is targeted by an intent to deemphasize) and proceed to step 510 to analyze the next frame.

At step 522, if such keywords or phrases are detected, then, at step 524, control circuitry 431 may proceed to assess another attribute of the text. For example, control circuitry 431 may determine the duration for which the text is displayed (e.g., tracking the temporal length of the text display based on timestamps associated with the display of the text in the video). However, if control circuitry 431 does not detect such keywords or phrases, then, at step 526, control circuitry 431 may ignore the text (e.g., classify the text as not including content that has been deemphasized and/or is targeted by an intent to deemphasize) and proceed to step 510 to analyze the next frame.

At step 528, if the display duration of the text is shorter than a particular duration, then, at step 530, control circuitry 431 may determine that the text includes content that has been deemphasized and/or is targeted by an intent to deemphasize. For example, control circuitry 431 may flag the text as fine print, bookmark the frame, or generate and store metadata based on the flagged text. However, if control circuitry 431 determines that the duration is equal to or longer than the particular duration, then control circuitry 431 may ignore the text and proceed to step 510 to analyze the next frame.

At step 534, control circuitry 431 may enhance the output of the text (e.g., by way of enhancements described above). Control circuitry 431 may then proceed to step 510 to analyze the next frame.

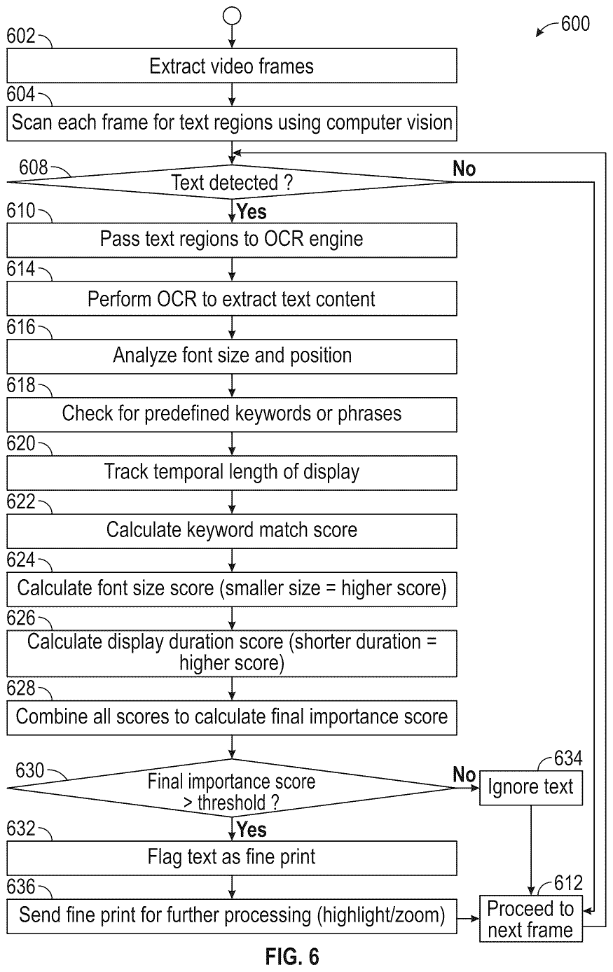

FIG. 6 is a flowchart of another example process 600 for identifying deemphasized textual content, in accordance with an embodiment of the disclosure. In some embodiments, at step 602, control circuitry 431 extracts one or more video frames of content (e.g., content 130 of FIG. 1 or content 230 of FIG. 2). Although video frames are shown in the example, it is understood that the process may be implemented for any other suitable content, including audio, textual, image, or audiovisual content.

At step 604, control circuitry 431 may scan each frame for text regions (e.g., by way of computer vision or other suitable image processing models to detect regions containing textual content).

At step 608, if control circuitry 431 detects text in a region of a frame, then, at steps 610 and 614, control circuitry 431 may extract the text (e.g., by way of OCR or other suitable models for converting the regions into machine-readable text). However, if control circuitry 431 does not detect text in the region, then control circuitry 431 may determine that the frame does not include content that has been deemphasized and/or targeted by an intent to deemphasize, and may proceed to step 612 to perform text detection in the next frame.

At steps 616, 618, 620, 622, 624, and 626 control circuitry 431 may analyze one or more attributes of the extracted text, and at step 628, calculates an importance score based on the analyzed attributes. For example, at step 616, control circuitry 431 may determine the font size and position of the text. At step 618, control circuitry 431 may determine the presence of one or more predefined keywords or phrases in the text. At step 620, control circuitry 431 may determine the display duration of the text with respect to the duration of one or more frames in the video. Based on analysis of these attributes, at steps 622, 624, 626, control circuitry 431 may calculate a keyword match score (e.g., higher match percentage or similarity percentage may correspond with a higher keyword match score), a font size score (e.g., smaller font size may correspond with a higher font size score), and a display duration score (e.g., shorter display duration may correspond with a higher display duration score), respectively. At step 628, control circuitry 431 may combine the scores into a final importance score and assign the score to the text.

At step 630, control circuitry 431 may compare the final importance score of the text to a threshold score. If the final importance score is greater than the threshold, then at step 632, control circuitry 431 may determine that the text includes content that has been deemphasized and/or is targeted by an intent to deemphasize. Otherwise, if the final importance score is equal to or below the threshold score, then, at step 634, control circuitry 431 may ignore the text (e.g., classify the text as not including content that has been deemphasized and/or is targeted by an intent to deemphasize) and proceed to step 612 to analyze the next frame.

At step 636, control circuitry 431 may perform enhancement of the text. Control circuitry 431 may then proceed to step 612 to analyze the next frame.

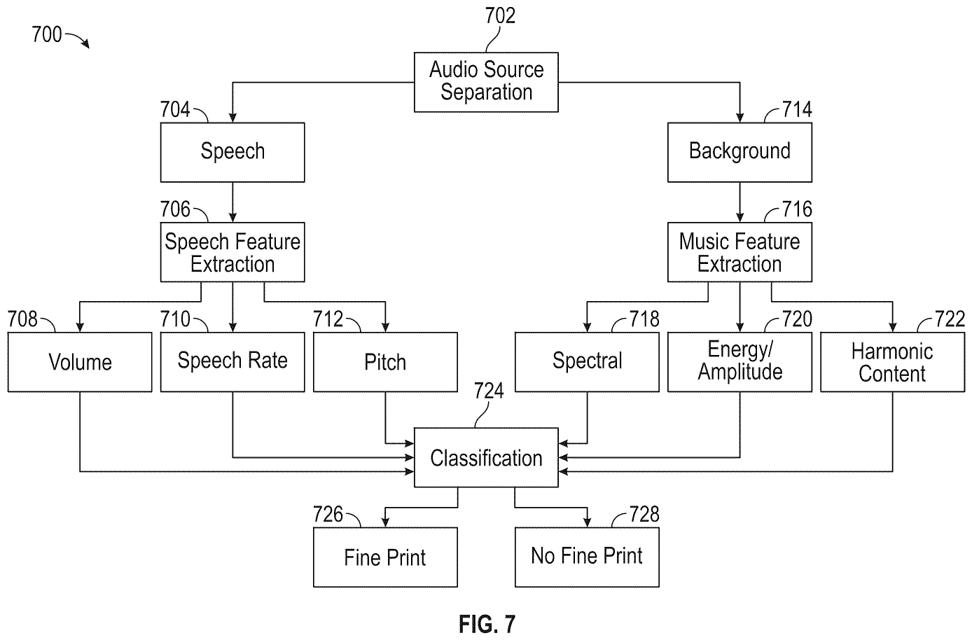

FIG. 7 is a flowchart of an example process 700 for identifying deemphasized audio content in accordance with an embodiment of the disclosure. In some embodiments, at step 702, control circuitry 431 may perform audio source separation on audio content (e.g., such as audio content associated with content 230 of FIG. 2). For example, the audio content may be separated into speech audio content 704 (e.g., which may correspond with audio 232 of FIG. 2) and background audio content 714 (e.g., which may correspond with background music 236 of FIG. 2). Although audio content is shown in the example, it is understood that the process may be implemented for any other suitable content, including textual, image, or audiovisual content.

With respect to the speech audio content 704, at step 706, control circuitry 431 may perform speech feature extraction or other suitable audio feature extraction (e.g., using NLP or other suitable language processing model). For example, control circuitry 431 may extract features such as volume 708, speech rate 710, pitch 712, other suitable audio features, or a combination thereof.

With respect to background audio content 714, at step 716, control circuitry 431 may perform musical feature extraction or other suitable audio feature extraction (e.g., using one or more suitable audio processing models). For instance, control circuitry 431 may extract spectral features 718, energy (e.g., amplitude) 720, harmonic content 722, other suitable audio features, or a combination thereof.

At step 724, control circuitry 431 may compare the extracted features of the speech audio 704 and the background audio 714. For instance, if the extracted features of speech audio 704, background audio 714, or both, have certain qualities (e.g., speech rate 710 of speech audio 704 is at a relatively high speed; musical background 714 is played at a high amplitude 720), then, at step 726, control circuitry 431 may determine that speech audio 704 includes content that has been deemphasized and/or is targeted by an intent to deemphasize. In some instances, control circuitry 431 may assign a score (e.g., an importance score) to the speech audio 704, background audio 714, or both, based on the extracted features. If the importance score of the speech audio 704 is above a particular threshold, then control circuitry 431 may determine that the speech audio 704 content that has been deemphasized and/or is targeted by an intent to deemphasize. However, if control circuitry 431 determines that the extracted features of speech audio 704, background audio 714, or both, do not have one or more of such qualities (or do not have a quality to a certain degree), then, at step 728, control circuitry 431 may determine that speech audio 704 does not include content that has been deemphasized and/or is targeted by an intent to deemphasize.

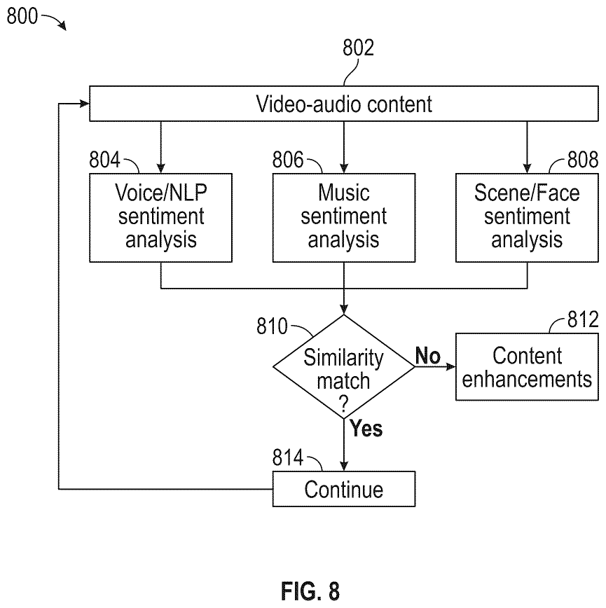

FIG. 8 is a flowchart of an example process 800 for identifying deemphasized video content in accordance with an embodiment of the disclosure. In some embodiments, at step 802, control circuitry 431 may extract one or more features from video-audio content, such as voice features (e.g., speech audio), background music, facial expressions, scenic features, or other suitable features. Although video-audio content is shown in the example, it is understood that the process may be implemented for any other suitable content, including textual, image, or other audiovisual content.

Control circuitry 431 is configured to determine a tone or sentiment (or other suitable attributes, such as speed or duration for which the feature is presented in the content) associated with each of these features. For instance, at step 804, control circuitry 431 may determine that speech audio of the video-audio content is associated with a serious sentiment. At step 806, control circuitry 431 may determine that background music is associated with a playful sentiment. At step 808, control circuitry 431 may determine that the overall scene or facial expressions of actors in the scene are associated with a cheerful sentiment.

At step 810, control circuitry 431 may compare the sentiment of each feature. For example, if control circuitry 431 determines that the sentiment of the speech audio is dissimilar to the sentiment of the background music, of the scene or facial expressions, or a combination thereof, then control circuitry 431 may determine that the speech audio includes content that has been deemphasized and/or is targeted by an intent to deemphasize. Consequently, at step 812, control circuitry 431 may perform enhancements on the speech audio content, such as by increasing its volume, slowing down its speech rate, or extending its duration. However, if control circuitry 431 determines that the sentiment of the speech audio has a certain level of similarity with the sentiment of the background music (e.g., at least 50% similarity or more), then, at step 814, control circuitry 431 may determine that the speech audio does not include content that has been deemphasized and/or targeted by an intent to deemphasize, and proceeds to analyze the sentiment of the next frame.

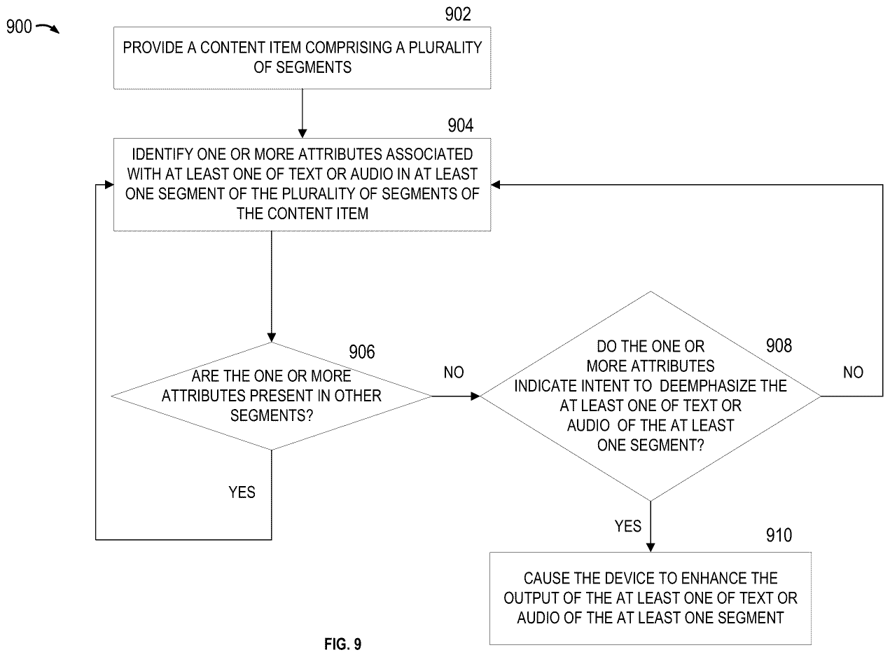

FIG. 9 is a flowchart of an example process 900 for providing enhancements for deemphasized content, in accordance with an embodiment of the disclosure. In some embodiments, at step 902, control circuitry 411 (e.g. of content server 404) provides a content item (e.g., content 130, 230) that includes a plurality of segments for presentation (e.g., on device 120, 220).

At step 904, control circuitry 431 (e.g., of UI enhancement server 424) may identify one or more attributes associated with text (e.g., text 132), audio (e.g., audio 232), or both, of at least one segment of the content item 130, 230. For instance, one such attribute may include small font size for the text, or low volume for the audio.

At step 906, control circuitry 431 may also determine whether these attributes are present in other segments and/or portions of the content item. For instance, control circuitry 431 may detect that other text (such as promotional header text) in the content item is presented in large font size, or other audio (such as background music) in the content item is presented in high volume. If the attributes are present in other segments, then the process reverts to step 904. If the attributes of these other segments are different and/or are not present from the attributes of the text or audio (e.g., by a certain degree), then, at step 908, control circuitry 431 may determine whether these attributes indicate an intent to deemphasize the text or audio. For instance, attributes such as a small font size or low audio volume may indicate an intent to deemphasize content having such attributes. If not, then the process reverts to step 904. If the attributes indicate such an intent, then, at step 910, control circuitry 431 may cause the device 120, 220 to enhance the output of the text, audio, or both (e.g., by increasing the font size or increasing the volume, or other suitable modification).

The processes discussed above are intended to be illustrative and not limiting. One skilled in the art would appreciate that the steps of the processes discussed herein may be added, omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A computer-implemented method comprising:
providing, for output on a device, a content item comprising a plurality of segments;
identifying one or more attributes associated with at least one of text or audio in at least one segment of the plurality of segments of the content item;
determining that the one or more attributes indicate an intent to deemphasize the at least one of text or audio of the at least one segment; and
based at least in part on determining that the one or more attributes indicate an intent to deemphasize the at least one of text or audio of the at least one segment, causing the device to enhance the output of the at least one of text or audio of the at least one segment.

2. The computer-implemented method of claim 1, wherein causing the device to enhance the output of the at least one of text or audio of the at least one segment is further based at least in part on:
obtaining user profile data; and
determining that content of the at least one of text or audio of the at least one segment is relevant to the user profile data.

3. The computer-implemented method of claim 1, wherein determining that the one or more attributes indicate an intent to deemphasize the at least one of text or audio of the at least one segment is further based at least in part on:
determining that metadata associated with the content item includes one or more keywords indicative of content targeted by the intent to deemphasize the at least one of text or audio of the at least one segment.

4. The computer-implemented method of claim 1, wherein the determining that the one or more attributes indicate an intent to deemphasize the at least one of text or audio is further based at least in part on:
identifying a region of text in the at least one segment; and
determining that the text includes one or more keywords indicative of content targeted by the intent to deemphasize the at least one of text or audio of the at least one segment.

5. The computer-implemented method of claim 1, wherein the determining that the one or more attributes indicate an intent to deemphasize the at least one of text or audio is further based at least in part on:
determining that at least a portion of the audio includes one or more keywords indicative of content targeted by the intent to deemphasize the at least one of text or audio of the at least one segment.

6. The computer-implemented method of claim 1, wherein the determining that the one or more attributes indicate an intent to deemphasize the at least one of text or audio is further based at least in part on at least one of a font size or location of the text in the at least one segment.

7. The computer-implemented method of claim 1, wherein the determining that the one or more attributes indicate an intent to deemphasize the at least one of text or audio further comprises:
identifying a speech portion of the audio of the at least one segment;
determining characteristics of the speech portion;
determining characteristics of other content portions of the at least one segment;
comparing the characteristics of the speech portion and the characteristics of the other content portions of the at least one segment; and
determining that a level of similarity between the compared characteristics is below a threshold.

8. The computer-implemented method of claim 7, wherein the characteristics comprise at least one of tone, speed, volume, pitch, or sentiment.

9. The computer-implemented method of claim 1, wherein the determining that the one or more attributes indicate an intent to deemphasize the at least one of text or audio is further based at least in part on a duration for which the text or audio is presented in the content item.

10. The computer-implemented method of claim 1, wherein causing the device to enhance the output of the at least one of text or audio of the at least one segment further comprises:
transmitting, to a second device, the at least one of text or audio of the at least one segment; and
causing the second device to present the at least one of text or audio of the at least one segment.

11. The computer-implemented method of claim 1, wherein causing the device to enhance the output of the at least one of text or audio of the at least one segment further comprises at least one magnifying, highlighting, increasing volume, decreasing speed, or extending duration of the at least one of text or audio of the at least one segment.

12. The computer-implemented method of claim 1, wherein causing the device to enhance the output of the at least one of text or audio of the at least one segment further comprises:
obtaining eye tracking data of a user viewing the content item;
based on the eye tracking data, identifying a location of the content item corresponding to a gaze of the user; and
displaying the text of the at least one segment at the identified location.

13. The computer-implemented method of claim 1, wherein causing the device to enhance the output occurs at a first time, and further comprises:
generating metadata based on content of the at least one of text or audio of the at least one segment that is relevant to user profile data;
detecting, at the device, a user action associated with an object featured in the content item; and
based on the detecting, generating an output based on the metadata; and
the method further comprising causing the device to provide the output at a second time after the first time.

14. The computer-implemented method of claim 1, wherein determining that the one or more attributes indicate an intent to deemphasize the at least one of text or audio of the at least one segment comprises determining that the one or more attributes of the at least one segment are not present in other segments of the plurality of segments.

15. A system comprising:
input/output circuitry configured to:
provide, for output on a device, a content item comprising a plurality of segments; and
control circuitry configured to:
identify one or more attributes associated with at least one of text or audio in at least one segment of the plurality of segments of the content item;
determine that the one or more attributes indicate an intent to deemphasize the at least one of text or audio of the at least one segment; and
based at least in part on determining that the one or more attributes indicate an intent to deemphasize the at least one of text or audio of the at least one segment, cause the device to enhance the output of the at least one of text or audio of the at least one segment.

16. The system of claim 15, wherein causing the device to enhance the output of the at least one of text or audio of the at least one segment is further based at least in part on:
obtaining user profile data; and
determining that content of the at least one of text or audio of the at least one segment is relevant to the user profile data.

17. The system of claim 15, wherein determining that the one or more attributes indicate an intent to deemphasize the at least one of text or audio of the at least one segment is further based at least in part on:
determining that metadata associated with the content item includes one or more keywords indicative of content targeted by the intent to deemphasize the at least one of text or audio of the at least one segment.

18. The system of claim 15, wherein the determining that the one or more attributes indicate an intent to deemphasize the at least one of text or audio is further based at least in part on:
identifying a region of text in the at least one segment; and
determining that the text includes one or more keywords indicative of content targeted by the intent to deemphasize the at least one of text or audio of the at least one segment.

19. The system of claim 15, wherein the determining that the one or more attributes indicate an intent to deemphasize the at least one of text or audio is further based at least in part on:
determining that at least a portion of the audio includes one or more keywords indicative of content targeted by the intent to deemphasize the at least one of text or audio of the at least one segment.

20. The system of claim 15, wherein the determining that the one or more attributes indicate an intent to deemphasize the at least one of text or audio is further based at least in part on at least one of a font size or location of the text in the at least one segment.

21-42. (canceled)
